(19) United States
(12) Patent Application Publication
(10) Pub. No.: US 2005/0084699 A1
(43) Pub. Date: Apr. 21, 2005

(54) Transparent and translucent multi-layer support with an iridesecent appearance

(76) Inventor: Gael Depres, Charavines (FR)

Correspondence Address: BIRCH STEWART KOLASCH & BIRCH, PO BOX 747, FALLS CHURCH, VA, 22040-0747, US

(21) Appl. No.: 10/504,289

(22) PCT Filed: Feb. 7, 2003
(86) PCT No.: PCT/FR03/00399

(30) Foreign Application Priority Data
Feb. 14, 2002 (FR) 02/01813

(51) Int. Cl. B32B 29/00

(52) U.S. Cl. 428/535

(57) ABSTRACT

The invention relates to a transparent or translucent iridescent support comprising at least two translucent or transparent sheets, preferably made from cellulose paper, respectively glued to the rear and the front of a transparent iridescent film by means of a glue or lacquer

The present invention relates to a transparent or translucent multilayer medium with an iridescent appearance.

Transparent or translucent papers may be obtained in various ways, either by chemical impregnation of the paper with a transparentizing substance, of the latex, wax or resin type, in which case they are called “artificial calking papers”, or by applying an agent intended to partly dissolve the fibers of the paper, for example using an acid, or else by relatively high refining of the cellulose fibers of the paper during preparation of the pulp.

The latter mode of formation results in what is called a “natural” tracing paper, as defined in International Standard ISO-4046-1978, item 6.94.

However, in the papermaking industry, it is conventional practice to use the term “tracing paper” for the specific case of a paper that has undergone high refining of these fibers.

Translucent or transparent papers obtained by light refining of their fibers followed by heavy calendaring, said paper being used especially for the manufacture of windows in certain envelopes, are generally grouped together under the specific name of “glassine paper”.

The Applicant has focused on the method of obtaining tracing papers by high refining of their fibers with the other methods mentioned above for resulting in the desired transparency or semitransparency characteristics.

In the rest of the presentation of the invention, for the sake of brevity, the term “tracing paper” will therefore refer to this preferred method of obtaining it.

Conventionally, transparent or translucent papers are intended to be used in the technical drawing field rather than in the printing, packaging or security fields.

However, according to the present invention, it is desired to provide a transparent or translucent medium with an iridescent appearance, either as a means of authentication, for example in the case of security papers, or for decorative purposes.

The use of an iridescent effect to solve problems in the falsification and counterfeiting of payment items and of official documents is known to those skilled in the art, especially from the Applicant's Patent FR 2 429 292.

Since the iridescent effect is characterized by particular optical effects, especially changes of reflections, tints or shades depending on the angle of observation, no photocopying system can reproduce these optical effects.

The iridescent effect has been obtained hitherto either by the bulk introduction of iridescent substances into the composition of the paper, or by mixing these same iridescent substances into a coating deposited on the surface of the paper, as Patent FR 2 790 014 discloses.

The term “iridescent substance” is understood to mean a substance that, according to the principle of the diffraction of light by thin films, causes reflections that depend on the angle of observation, the colors of which cover the rainbow spectrum into which white light is split.

Among the iridescent substances frequently used, mention may especially be made of mother-of-pearl extracts, lead salts and micas.

These prior techniques have a number of drawbacks.

Firstly, the surface or bulk application of iridescent substances may result in areas of additional thickness or surface irregularities that are undesirable on account of their size.

Tracing paper coated with this iridescent layer does not have the same surface smoothness or the same printability.

This phenomenon may prove to be incompatible with the basic requirements of the product, especially in applications where the surface finish plays a not insignificant role.

Secondly, the application of a layer of iridescent substances may modify the dimensional stability of the tracing paper.

The tracing paper, being a highly fibrillated paper, is very sensitive to moisture. By coating a tracing paper with an aqueous suspension, there is a risk of irreversible cockling, which is particularly irksome when the paper is used especially for decorative and/or printing purposes.

Finally, to a lesser extent, the tracing paper may lose its transparency because of the presence of these iridescent substances, particularly in areas in which there is a high concentration of substances.

To remedy this, the Applicant had the idea of using a transparent iridescent film instead of the iridescent substances, which film is laminated to a tracing paper.

Such iridescent films are in particular manufactured by Engelhard Corporation under the brand name “AURORA”.

These are in general laminated sheets of transparent thermoplastic resins consisting of at least ten very thin layers with a uniform thickness of between about 30 and 500 nm, said layers often being parallel, and a surface of two of said layers constituting the outer surfaces of the laminated sheet, the contiguous adjacent layers being made of transparent thermoplastic resinous material and possessing refractive indices that differ by at least 0.03.

These co-extruded sheets possess a narrow reflection band owing to the interference of light through the superposition of layers thus formed.

When the reflection band lies in the visible wavelength range, the film is iridescent.

Similarly, when the reflection band lies outside the visible wavelength, the film reflects either in the ultraviolet or in the infrared.

One of the applications of this film is packaging.

It is then laminated to a plastic or paper backing in order to give it sufficient strength.

However, to the applicant's knowledge, there do not exist at the present time iridescent tracing papers obtained by lamination of such a film between two sheets of tracing paper.

This solution has the advantage of providing a medium that retains, on the outside, all the qualities of a tracing paper, namely transparency, appearance, feel and printability, while having an iridescent appearance.

This is particularly beneficial for use in printing or writing, in which, compared with virgin tracing paper, a coated iridescent tracing paper exhibits rather poor printability characteristics, especially in dusting tests.

It is also found that there is a difference in iridescence between a coated iridescent paper and a laminated iridescent tracing paper according to the invention.

In the case of a coated iridescent tracing paper, the iridescence effect is uniform and always visible whatever the viewing angle.

In contrast, the laminated iridescent tracing paper of the invention exhibits nonuniform iridescence, that varies depending on the viewing angle.

This can present a not insignificant additional obstacle when forgery is attempted.

One of the problems to be solved in our invention was to ensure that the film and the tracing paper were laminated both securely and discreetly.

Given the nature of the constituents, the choice of adhesive is paramount.

Since the tracing paper is sensitive to moisture, excessively aqueous adhesives cause shrinkage and cockling phenomena.

The film itself runs the risk of degrading with certain solvent-based adhesives.

The invention therefore aims to solve these problems.

The object of the present invention is therefore to provide a transparent or translucent and iridescent medium comprising at least two transparent or translucent sheets, preferably made of cellulose paper, that are bonded to the front and back, respectively, of a transparent iridescent film by means of an adhesive or a varnish.

According to a preferred embodiment of the invention, the transparent or translucent sheets possess a white-backing opacity of less than or equal to 90%, said opacity being measured according to the NF Q 03-006 standard.

According to one particular embodiment of the invention, the transparent or translucent sheets are tracing papers.

According to one embodiment, the adhesive used is an aqueous pressure-sensitive adhesive, preferably of the Findley FINDTACK 1100 type or 3M 7434 type.

In this embodiment, the adhesive is firstly applied to the film, advantageously by spraying droplets of the aqueous-based adhesive onto the film, which then undergoes a drying operation intended to evaporate the aqueous phase of the adhesive, before finally being brought into contact with the sheets of tracing paper.

According to another embodiment, the adhesive used is a solvent based-adhesive, the solvent preferably being an alcohol such as ethanol or isopropanol, or an aliphatic hydrocarbon, such as hexane or naphtha, and advantageously of the SCOTCH-GRIP 7312 type supplied by 3M.

According to a preferred embodiment of the invention, the film used is a transparent iridescent multilayer plastic film of the AURORA type produced by Engelhard Corporation.

According to another embodiment, the laminating is carried out using a heat-sealable varnish applied to the film and hot-pressed with the transparent or translucent sheets, the varnish advantageously being of the LATISEAL A7734A type supplied by Sovereign.

It may also be envisioned to provide an iridescent film initially precoated with a heat-sealable varnish so as to facilitate the laminating step.

As an implementation example, the Applicant manufactured a 140 g/m² iridescent translucent medium by laminating:
an iridescent film of the AURORA IF 8631 RG type with a thickness of 33 micrometers, between
two 60 g/m² tracing papers.

The lamination was carried out using a 3M adhesive called SCOTCH-GRIP 7312. The paper thus obtained had iridescent effects and retained a more than acceptable white-backing opacity (72% instead of 40% in the case of a tracing paper of the same grammage).

It is also possible to envisage the use of colored tracing papers or tracing papers having very specific particles, such as fluorescent, ferromagnetic or thermo chromic particles in the form of fibers, pigments or flakes, on at least one side of the medium or coated with a layer giving them a decorative appearance for making them able to be written or printed upon, although the presence of these colorants, these particles or these layers must not occlude the iridescent effect of the subjacent film.

1. A translucent or transparent and iridescent medium comprising at least two transparent or translucent sheets, preferably made of cellulose paper, that are bonded to the front and back, respectively, of a transparent iridescent film by means of an adhesive or a varnish:

2. The medium as claimed in claim 1, characterized in that the transparent or translucent sheets possess a white-backing opacity of less than or equal to 90%, said opacity being measured according to the NF Q 03-006 standard.

3. The medium as claimed in claim 1 or 2, characterized in that the transparent or translucent sheets are tracing papers.

4. The medium as claimed in claim 3, characterized in that the adhesive used is an aqueous pressure-sensitive adhesive.

5. The medium as claimed in claim 1, characterized in that the adhesive used is a solvent based-adhesive, the solvent preferably being an alcohol such as ethanol or isopropanol, or an aliphatic hydrocarbon, such as hexane or naphtha.

6. The medium as claimed in claim 1, characterized in that the laminating is carried out using a heat-sealable varnish applied to the film and hot-pressed with the transparent or translucent sheets.

7. The medium as claimed in claim 1, characterized in that the film used is an iridescent transparent multilayer plastic film.
